(19) United States
(12) Patent Application Publication
(10) Pub. No.: US 2026/0088001 A1
(43) Pub. Date: Mar. 26, 2026

(54) DISPLAY CONTROL CIRCUIT FOR DETECTING NOISE INTERFERENCE AND CONTROL METHOD THEREOF

(71) Applicant: NOVATEK MICROELECTRONICS CORP., HSINCHU (TW)

(72) Inventors: HSUAN-YA HSU, TAICHUNG CITY (TW); JEN-CHIEH HU, HSINCHU COUNTY (TW); TSE-HUNG WU, HSINCHU CITY (TW); CHIN-HUNG HSU, TAOYUAN CITY (TW)

(21) Appl. No.: 18/895,957

(22) Filed: Sep. 25, 2024

(51) Int. Cl. G09G 3/36

(52) U.S. Cl. CPC G09G 3/3648; G09G 2230/00; G09G 2310/061; G09G 2310/08; G09G 2330/026; G09G 2330/06

(57) ABSTRACT

The disclosure describes a display control circuit for detecting noise interference and a control method thereof. The display control circuit includes a display driver and a timing controller. The timing controller is coupled to the display driver. In the control method, the display driver sets an asynchronization signal which indicates that the timing controller is desynchronized from the display driver. The display driver performs a noise interference mode when the display driver or the timing controller determines that the time duration of the asynchronization signal is less than a given time duration. The display driver performs a crash reset mode after the noise interference mode is performed when the display driver or the timing controller determines that the time duration of the asynchronization signal is equal to or greater than the given time duration.

### BACKGROUND OF THE INVENTION

### Field of the Invention

The invention relates to display technology, particularly to a display control circuit for detecting noise interference and a control method thereof.

### Description of the Related Art

Each pixel of a liquid-crystal display (LCD) typically consists of a layer of molecules aligned between two transparent electrodes, often made of indium tin oxide (ITO) and two polarizing filters, the polarizing directions of which are (in most of the cases) perpendicular to each other. Without the liquid crystal between the polarizing filters, light passing through the first filter would be blocked by the second polarizer. Before an electric field is applied, the orientation of the liquid-crystal molecules is determined by the alignment at the surfaces of electrodes. In a twisted nematic (TN) device, the surface alignment directions at the two electrodes are perpendicular to each other, and so the molecules arrange themselves in a helical structure, or twist. This induces the rotation of the polarization of the incident light, and the device appears gray. If the applied voltage is large enough, the liquid crystal molecules in the center of the layer are almost completely untwisted and the polarization of the incident light is not rotated as it passes through the liquid crystal layer. This light will then be mainly polarized perpendicular to the second filter, and thus be blocked and the pixel will appear black. By controlling the voltage applied across the liquid crystal layer in each pixel, light can be allowed to pass through in varying amounts thus constituting different levels of gray. As mentioned above, the twisting and transmittance of liquid crystal are controlled by a voltage across the liquid crystal, which is a difference between a pixel voltage and a common electrode voltage. If the voltage across liquid crystal maintains a direct-current (DC) voltage with a single polarity for a long time, it will cause the mobile ions in the liquid crystal to move in the same direction. This movement creates an electric field with charges of opposite polarity on the electrodes, thereby affecting the alignment and transmittance of liquid crystal and leading to polarization.

### SUMMARY OF THE INVENTION

The invention provides a display control circuit for detecting noise interference and a control method thereof, which avoid screen abnormalities and afterimage retention.

In an embodiment of the invention, the control method of a display control circuit that includes a timing controller and a display driver includes: setting an asynchronization signal which indicates that the timing controller is desynchronized from the display driver; when determining that a time duration of the asynchronization signal is less than a given time duration, performing a noise interference mode; and after performing the noise interference mode and when determining that the time duration of the asynchronization signal is equal to or greater than the given time duration, performing a crash reset mode.

In an embodiment of the invention, a display control circuit includes a timing controller and a display driver. The display driver is coupled to the timing controller and configured to set an asynchronization signal which indicates that the timing controller is desynchronized from the display driver. When the timing controller determines that the time duration of the asynchronization signal is less than a given time duration, the display driver performs a noise interference mode. After the noise interference mode is performed and when the timing controller determines that the time duration of the asynchronization signal is equal to or greater than the given time duration, the display driver performs a crash reset mode.

In an embodiment of the invention, a display control circuit includes a timing controller and a display driver. The display driver is coupled to the timing controller and configured to set an asynchronization signal which indicates that the timing controller is desynchronized from the display driver. When the display driver determines that the time duration of the asynchronization signal is less than a given time duration, the display driver performs a noise interference mode. After the noise interference mode is performed and when the display driver determines that the time duration of the asynchronization signal is equal to or greater than the given time duration, the display driver performs a crash reset mode.

To sum up, the display control circuit for detecting noise interference and the control method thereof perform a noise interference mode or a crash reset mode based on a given time duration and the time duration of an asynchronization signal which indicates that the timing controller is desynchronized from the display driver, thereby avoiding screen abnormalities and afterimage retention.

Below, the embodiments are described in detail in cooperation with the drawings to make easily understood the technical contents, characteristics and accomplishments of the invention.

### BRIEF DESCRIPTION OF THE DRAWINGS

FIG. 1 is a diagram schematically illustrating a display control circuit according to a first embodiment of the invention;

FIG. 2 is a diagram schematically illustrating a pixel equivalent circuit according to an embodiment of the invention;

FIG. 3 is a diagram schematically illustrating the status of driving voltage and the waveforms of a synchronization signal, an asynchronization signal, a wake signal, a pixel voltage, and a common voltage according to an embodiment of the invention;

FIG. 4 is a flowchart of a control method of a display control circuit according to a first embodiment of the invention;

FIG. 5 is a diagram schematically illustrating the screen presentation of a display panel corresponding to FIG. 3;

FIG. 6 is a diagram schematically illustrating a display control circuit according to a second embodiment of the invention;

FIG. 7 is a diagram schematically illustrating the status of driving voltage and the waveforms of a synchronization signal, an asynchronization signal, a wake signal, a pixel voltage, and a common voltage according to another embodiment of the invention;

FIG. 8 is a flowchart of a control method of a display control circuit according to a second embodiment of the invention;

FIG. 9 is a diagram schematically illustrating the screen presentation of a display panel corresponding to FIG. 7;

FIG. 10 is a diagram schematically illustrating the status of driving voltage and the waveforms of a synchronization signal, an asynchronization signal, a wake signal, a pixel voltage, and a common voltage according to further embodiment of the invention;

FIG. 11 is a diagram schematically illustrating the screen presentation of a display panel corresponding to FIG. 10;

FIG. 12 is a diagram schematically illustrating a display control circuit according to a third embodiment of the invention;

FIG. 13 is a diagram schematically illustrating the status of driving voltage and the waveforms of a synchronization signal, an asynchronization signal, a polarity signal, a pixel voltage, and a common voltage according to an embodiment of the invention;

FIG. 14 is a diagram schematically illustrating the pixels of a display panel for performing dot inversion according to an embodiment of the invention;

FIG. 15 is a diagram schematically illustrating the screen presentation of a display panel corresponding to FIG. 13; and

FIG. 16 is a diagram schematically illustrating a display control circuit according to a fourth embodiment of the invention.

### DETAILED DESCRIPTION OF THE INVENTION

Reference will now be made in detail to embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

Unless otherwise specified, some conditional sentences or words, such as “can”, “could”, “might”, or “may”, usually attempt to express what the embodiment in the invention has, but it can also be interpreted as a feature, element, or step that may not be needed. In other embodiments, these features, elements, or steps may not be required.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Certain terms are used throughout the description and the claims to refer to particular components. One skilled in the art appreciates that a component may be referred to using different names. This disclosure does not intend to distinguish between components that differ in name but not in function. In the description and in the claims, the term “comprise” is used in an open-ended fashion, and thus should be interpreted to mean “include, but not limited to.” The phrases “be coupled to,” “couples to,” and “coupling to” are intended to encompass any indirect or direct connection. Accordingly, if this disclosure mentions that a first device is coupled with a second device, it means that the first device may be directly or indirectly connected to the second device through electrical connections, wireless communications, optical communications, or other signal connections with/without other intermediate devices or connection means.

The invention is particularly described with the following examples which are only for instance. Those skilled in the art will readily observe that numerous modifications and alterations of the device and method may be made while retaining the teachings of the invention. Accordingly, the following disclosure should be construed as limited only by the metes and bounds of the appended claims. In the whole patent application and the claims, except for clearly described content, the meaning of the articles “a” and “the” includes the meaning of “one or at least one” of the elements or components. Moreover, in the whole patent application and the claims, except that the plurality can be excluded obviously according to the context, the singular articles also contain the description for the plurality of elements or components. In the entire specification and claims, unless the contents clearly specify the meaning of some terms, the meaning of the article “wherein” includes the meaning of the articles “wherein” and “whereon”. The meanings of every term used in the present claims and specification refer to a usual meaning known to one skilled in the art unless the meaning is additionally annotated. Some terms used to describe the invention will be discussed to guide practitioners about the invention. The examples in the present specification do not limit the claimed scope of the invention.

In the following description, a display control circuit for detecting noise interference and a control method thereof will be provided, which perform a noise interference mode or a crash reset mode based on a given time duration and the time duration of an asynchronization signal for desynchronizing the timing controller from the display driver, thereby avoiding screen abnormalities and afterimage retention.

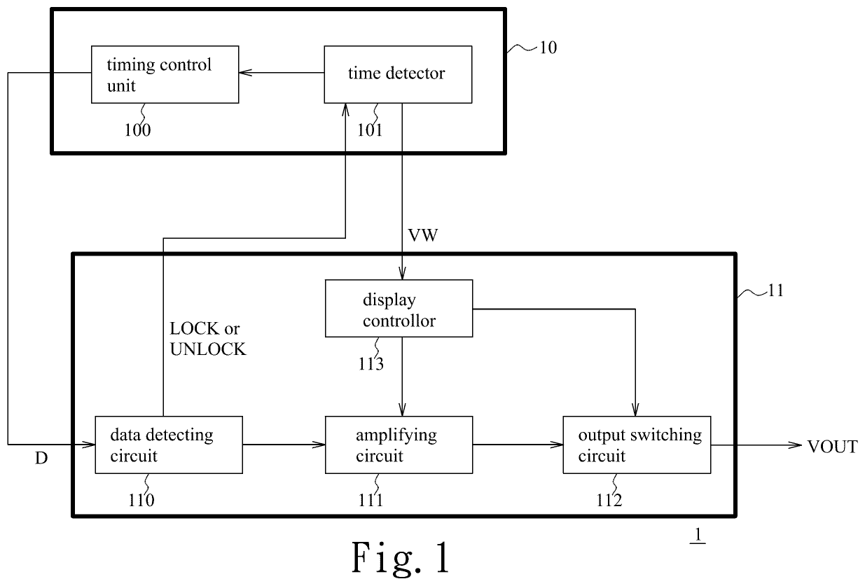

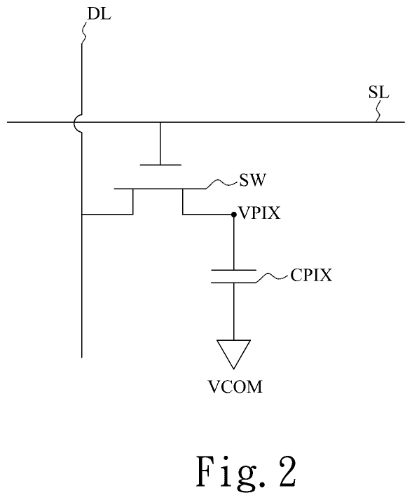

FIG. 1 is a diagram schematically illustrating a display control circuit according to a first embodiment of the invention. FIG. 2 is a diagram schematically illustrating a pixel equivalent circuit according to an embodiment of the invention. Referring to FIG. 1 and FIG. 2, the first embodiment of a display control circuit 1 will be introduced as follows. The display control circuit 1 includes a timing controller 10 and a display driver 11. The display driver 11 is coupled to the timing controller 10 and a data line DL. The data line DL and a scan line SL are coupled to a transistor switch SW. The transistor switch SW is coupled to a common voltage VCOM through a pixel liquid-crystal capacitor CPIX with a common electrode. The pixel liquid-crystal capacitor CPIX includes a liquid-crystal capacitor and a storage capacitor that are coupled in parallel.

The display driver 11 receives input data D from the timing controller 10 to generate a driving voltage VOUT. The driving voltage VOUT is applied to the data line DL to generate a pixel voltage VPIX between the transistor switch SW and the pixel liquid-crystal capacitor CPIX. The display driver 11 can set a synchronization signal LOCK which indicates that the timing controller 10 is synchronized with the display driver 11 in a normal status. Alternatively, the display driver 11 can set an asynchronization signal UNLOCK which indicates that the timing controller 10 is desynchronized from the display driver 11 when the display driver 11 detects noise interference. The display driver 11 transmits the synchronization signal LOCK or the asynchronization signal UNLOCK to the timing controller 10. The timing controller 10 determines the time duration of the asynchronization signal UNLOCK. The timing controller 10 provides a wake signal VW for the display driver 11 based on a given time duration and the time duration of the asynchronization signal UNLOCK. The given time duration may be, but not limited to, a time duration for enabling at least one scan line SL, sequentially enabling several scan lines SL, or displaying at least one image frame.

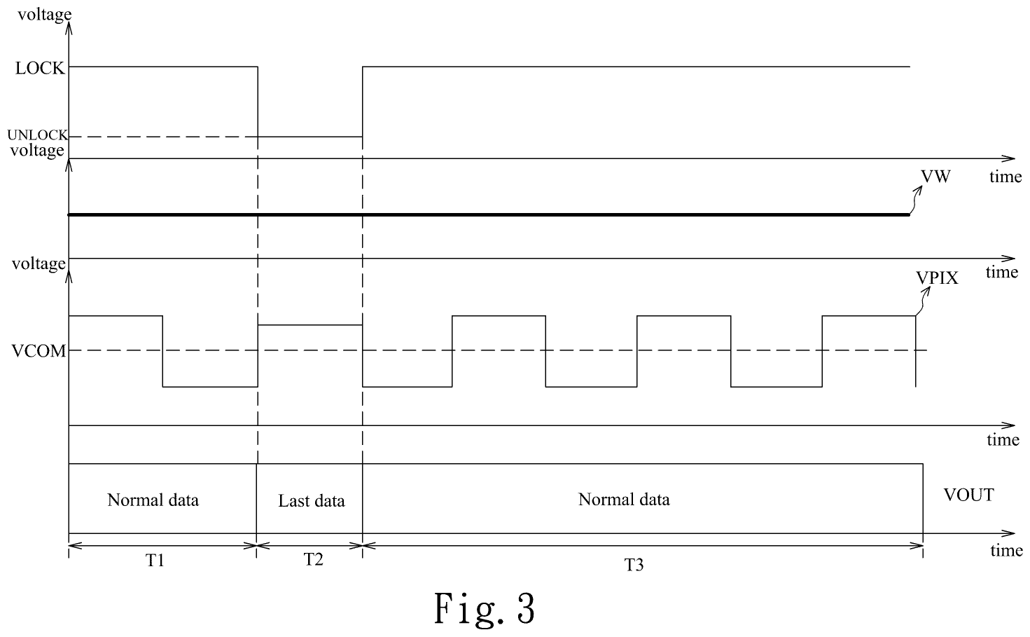

FIG. 3 is a diagram schematically illustrating the status of driving voltage and the waveforms of a synchronization signal, an asynchronization signal, a wake signal, a pixel voltage, and a common voltage according to an embodiment of the invention. Referring to FIG. 1, FIG. 2, and FIG. 3, time periods T1, T2, and T3 sequentially occurs. In time period T1, the display driver 11 sets the synchronization signal LOCK being a high-level voltage and transmits the synchronization signal LOCK to the timing controller 10. Simultaneously, the wake signal VW is a high-level voltage and the driving voltage VOUT comes from normal data. In time period T2, the display driver 11 sets the asynchronization signal UNLOCK being a low-level voltage. In time period T2, the timing controller 10 determines that the time duration of the asynchronization signal UNLOCK is less than the given time duration, such that the display driver 11 performs a noise interference mode and the wake signal VW is still a high-level voltage. In the noise interference mode, the display driver 11 may keep the last driving voltage VOUT and the corresponding pixel voltage VPIX prior to occurrence of the asynchronization signal UNLOCK for the time duration of the asynchronization signal UNLOCK. The last driving voltage VOUT corresponds to the last data. The pixel voltage VPIX and the common voltage VCOM are respectively represented with a solid line and a dashed line. In time period T3, the display driver 11 sets the synchronization signal LOCK being a high-level voltage and transmits the synchronization signal LOCK to the timing controller 10. Simultaneously, the wake signal VW is still a high-level voltage and the display driver 11 receives input data D from the timing controller 10 to generate new driving voltage VOUT that comes from normal data.

In an embodiment of the invention, the timing controller 10 may include, but is not limited to, a timing control unit 100 and a time detector 101. The timing control unit 100 is coupled to the display driver 11. The time detector 101 is coupled to the timing control unit 100 and the display driver 11. The timing control unit 100 generates the input data D. The time detector 101 receives the synchronization signal LOCK or the asynchronization signal UNLOCK, stores the given time duration, determines the time duration of the asynchronization signal UNLOCK, and provides the wake signal VW for the display driver 11 based on the given time duration and the time duration of the asynchronization signal UNLOCK.

In an embodiment of the invention, the display driver 11 may include, but is not limited to, a data detecting circuit 110, an amplifying circuit 111, an output switching circuit 112, and a display controller 113. The amplifying circuit 111 is coupled to the data detecting circuit 110, the output switching circuit 112, and the display controller 113. The display controller 113 is coupled to the output switching circuit 112 and the time detector 101. The data detecting circuit 110 is coupled to the timing control unit 100 and the time detector 101. The output switching circuit 112 is coupled to the data line DL. The data detecting circuit 110 receives the input data D to set the synchronization signal LOCK or the asynchronization signal UNLOCK and transmits the synchronization signal LOCK or the asynchronization signal UNLOCK to the time detector 101. The data detecting circuit 110, the amplifying circuit 111, and the output switching circuit 112 receive the input data D to generate the driving voltage VOUT. The display controller 113 receives the wake signal VW to control the amplifying circuit 111 and the output switching circuit 112.

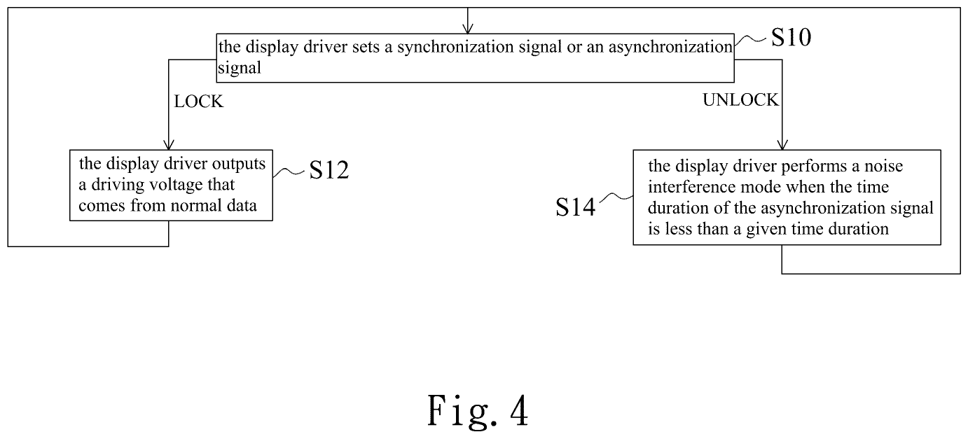

FIG. 4 is a flowchart of a control method of a display control circuit according to a first embodiment of the invention. Referring to FIG. 1, FIG. 3, and FIG. 4, the first embodiment of the control method will be introduced as follows. In Step S10, the display driver 11 sets a synchronization signal LOCK or an asynchronization signal UNLOCK. When the display driver 11 sets the synchronization signal LOCK, Step S12 is performed. In Step S12, the display driver 11 outputs a driving voltage VOUT that comes from normal data. After Step S12, the process returns to Step S10. When the display driver 11 sets the asynchronization signal UNLOCK, Step S14 is performed. In Step S14, the display driver 11 performs a noise interference mode when the time duration of the asynchronization signal UNLOCK is less than a given time duration. In the noise interference mode, the display driver 11 may keep the last driving voltage VOUT for the time duration of the asynchronization signal UNLOCK. After Step S14, the process returns to Step S10. Provided that substantially the same result is achieved, the steps of the flowchart shown in FIG. 4 need not be in the exact order shown and need not be contiguous, that is, other steps can be intermediate.

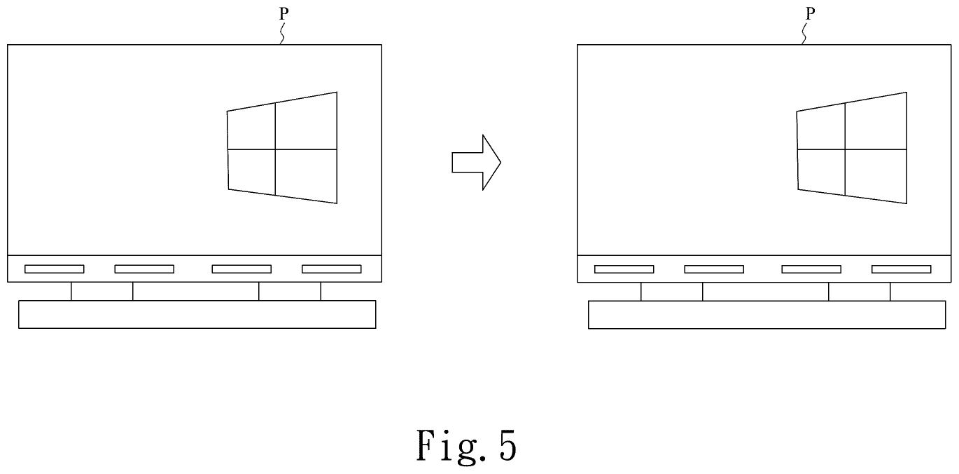

FIG. 5 is a diagram schematically illustrating the screen presentation of a display panel corresponding to FIG. 3. Referring to FIG. 3 and FIG. 5, the left display panel P shows a window in time periods T1 and T2 and the right display panel P shows a window in time period T3. Accordingly, the screen presentation of the left display panel P is the same as the screen presentation of the right display panel P. Thus, the control method can avoid screen abnormalities after noise interference is detected for a short time.

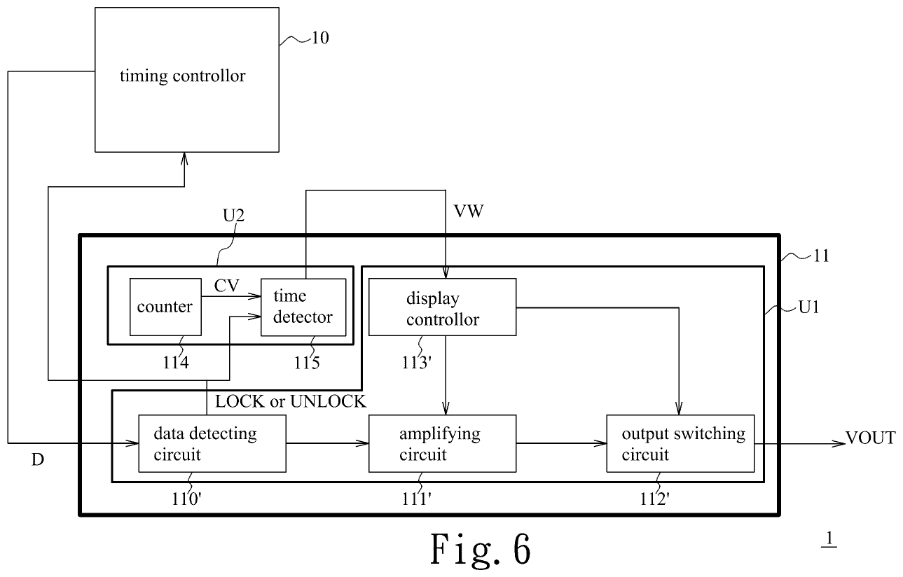

FIG. 6 is a diagram schematically illustrating a display control circuit according to a second embodiment of the invention. Referring to FIG. 6 and FIG. 2, the second embodiment of a display control circuit 1 will be introduced as follows. The display control circuit 1 includes a timing controller 10 and a display driver 11. The display driver 11 is coupled to the timing controller 10 and a data line DL.

The display driver 11 receives input data D from the timing controller 10 to generate a driving voltage VOUT. The driving voltage VOUT are applied to the data line DL to generate a pixel voltage VPIX between the transistor switch SW and the pixel liquid-crystal capacitor CPIX. The display driver 11 can set a synchronization signal LOCK for synchronizing the timing controller 10 with the display driver 11 in a normal status. Alternatively, the display driver 11 can set an asynchronization signal UNLOCK for desynchronizing the timing controller 10 from the display driver 11 when the display driver 11 detects noise interference. The display driver 11 transmits the synchronization signal LOCK or the asynchronization signal UNLOCK to the timing controller 10. The display driver 11 determines the time duration of the asynchronization signal UNLOCK by itself. The display driver 11 generates a wake signal VW therein based on a given time duration and the time duration of the asynchronization signal UNLOCK. The given time duration may be, but not limited to, a time duration for enabling at least one scan line SL, sequentially enabling scan lines SL, or displaying at least one image frame.

Referring to FIG. 6, FIG. 2, and FIG. 3, time periods T1, T2, and T3 sequentially occurs. In time period T1, the display driver 11 sets the synchronization signal LOCK being a high-level voltage and transmits the synchronization signal LOCK to the timing controller 10. Simultaneously, the wake signal VW is a high-level voltage and the driving voltage VOUT comes from normal data. In time period T2, the display driver 11 sets the asynchronization signal UNLOCK being a low-level voltage. In time period T2, the display driver 11 determines that the time duration of the asynchronization signal UNLOCK is less than the given time duration, such that the display driver 11 performs a noise interference mode and the wake signal VW is still a high-level voltage. In the noise interference mode, the display driver 11 may keep the last driving voltage VOUT for the time duration of the asynchronization signal UNLOCK. In time period T3, the display driver 11 sets the synchronization signal LOCK being a high-level voltage and transmits the synchronization signal LOCK to the timing controller 10. Simultaneously, the wake signal VW is still a high-level voltage and the display driver 11 receives input data D from the timing controller 10 to generate new driving voltage VOUT that comes from normal data.

In an embodiment of the invention, the display driver 11 may include, but is not limited to, a display driving unit U1 and a time detecting unit U2. The display driving unit U1 is coupled to timing controller 10 and the time detecting unit U2. The display driving unit U1 receives the input data D to set the synchronization signal LOCK or the asynchronization signal UNLOCK and transmits the synchronization signal LOCK or the asynchronization signal UNLOCK to the timing controller 10 and the time detecting unit U2. The time detecting unit U2 has an independent power source. The time detecting unit U2 determines the time duration of the asynchronization signal UNLOCK and provides the wake signal VW for the display driving unit U1 based on the time duration of the asynchronization signal UNLOCK and the given time duration. When the display driving unit U1 sets the asynchronization signal UNLOCK, the display driving unit U1 does not affect the time detecting unit U2 to determine the time duration of the asynchronization signal UNLOCK because the time detecting unit U2 has the independent power source.

In an embodiment of the invention, the display driving unit U1 may include, but is not limited to, a data detecting circuit 110′, an amplifying circuit 111′, an output switching circuit 112′, and a display controller 113′. The amplifying circuit 111′ is coupled to the data detecting circuit 110′, the output switching circuit 112′, and the display controller 113′. The display controller 113′ is coupled to the output switching circuit 112′ and the time detecting unit U2. The data detecting circuit 110′ is coupled to the timing controller 10 and the time detecting unit U2. The output switching circuit 112′ is coupled to the data line DL. The data detecting circuit 110′ receives the input data D to set the synchronization signal LOCK or the asynchronization signal UNLOCK and transmits the synchronization signal LOCK or the asynchronization signal UNLOCK to the timing controller 10 and the time detecting unit U2. The data detecting circuit 110′, the amplifying circuit 111′, and the output switching circuit 112′ receive the input data D to generate the driving voltage VOUT. The display controller 113′ receives the wake signal VW to control the amplifying circuit 111′ and the output switching circuit 112′.

In an embodiment of the invention, the time detecting unit U2 may include, but is not limited to, a counter 114 and a time detector 115. The time detector 115 is coupled to the counter 114 and the data detecting circuit 110′ of the display driving unit U1. The counter 114 provides a count value CV because the counter 114 has the independent power source. The time detector 115 receives either the synchronization signal LOCK or the asynchronization signal UNLOCK, the counter value CV, determines the time duration of the asynchronization signal UNLOCK based on the count value CV, and provides the wake signal VW for the display controller 113′ based on the given time duration and the time duration of the asynchronization signal UNLOCK.

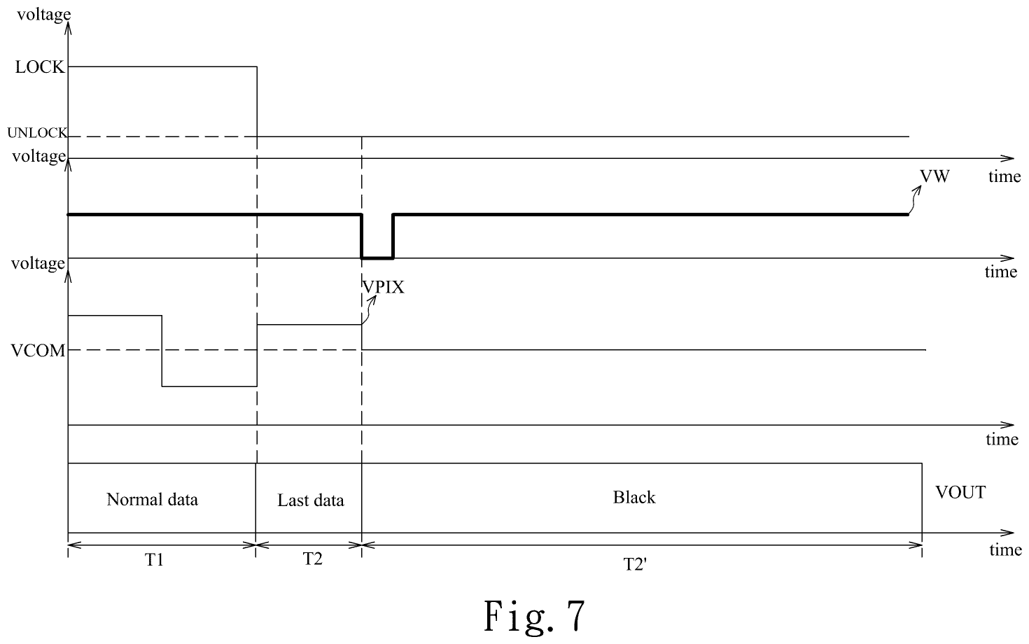

FIG. 7 is a diagram schematically illustrating the status of driving voltage and the waveforms of a synchronization signal, an asynchronization signal, a wake signal, a pixel voltage, and a common voltage according to another embodiment of the invention. Referring to FIG. 1, FIG. 2, and FIG. 7, time periods T1, T2, and T2′ sequentially occurs. In time period T1, the display driver 11 sets the synchronization signal LOCK being a high-level voltage and transmits the synchronization signal LOCK to the timing controller 10. Simultaneously, the wake signal VW is a high-level voltage and the driving voltage VOUT comes from normal data. In time period T2, the display driver 11 sets the asynchronization signal UNLOCK being a low-level voltage. In time period T2, the timing controller 10 determines that the time duration of the asynchronization signal UNLOCK is less than the given time duration, such that the display driver 11 performs a noise interference mode and the wake signal VW is still a high-level voltage. In the noise interference mode, the display driver 11 may keep the last driving voltage VOUT for the time duration of the asynchronization signal UNLOCK. In time period T2′ and after the noise interference mode, the timing controller 10 determines that the time duration of the asynchronization signal UNLOCK is greater than or equal to the given time duration, such that the display driver 11 performs a crash reset mode and the wake signal VW has a negative pulse. In the crash reset mode, the display driver 11 may adjust the last diving voltage VOUT prior to occurrence of the asynchronization signal UNLOCK to be equal to the common voltage VCOM applied to the common electrode of the pixel liquid-crystal capacitor CPIX. As a result, the pixel voltage VPIX is finally equal to the common voltage VCOM.

In some embodiments of the invention, the display controller 113 receives the negative pulse of the wake signal VW to control the amplifying circuit 111 and the output switching circuit 112, thereby adjusting the last diving voltage VOUT to be equal to the common voltage VCOM applied to the common electrode of the pixel liquid-crystal capacitor CPIX then the black picture is displayed.

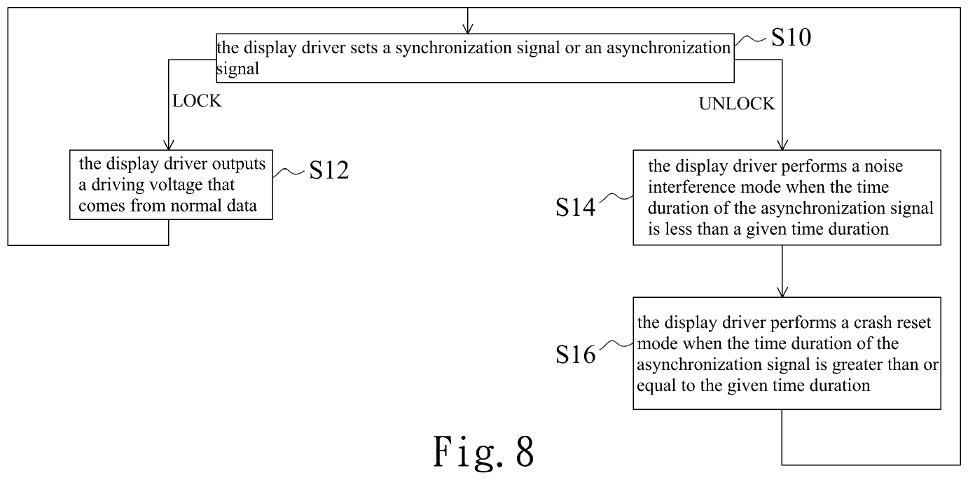

FIG. 8 is a flowchart of a control method of a display control circuit according to a second embodiment of the invention. Referring to FIG. 1, FIG. 7, and FIG. 8, the second embodiment of the control method will be introduced as follows. Steps S10, S12, and S14 have been described previously so they will not be reiterated. After Step S14, Step S16 is performed. In Step S16, the display driver 11 performs a crash reset mode when the time duration of the asynchronization signal UNLOCK is greater than or equal to the given time duration. In the crash reset mode, the display driver 11 may adjust the last diving voltage VOUT to be equal to the common voltage VCOM. After Step S16, the process returns to Step S10. Provided that substantially the same result is achieved, the steps of the flowchart shown in FIG. 8 need not be in the exact order shown and need not be contiguous, that is, other steps can be intermediate.

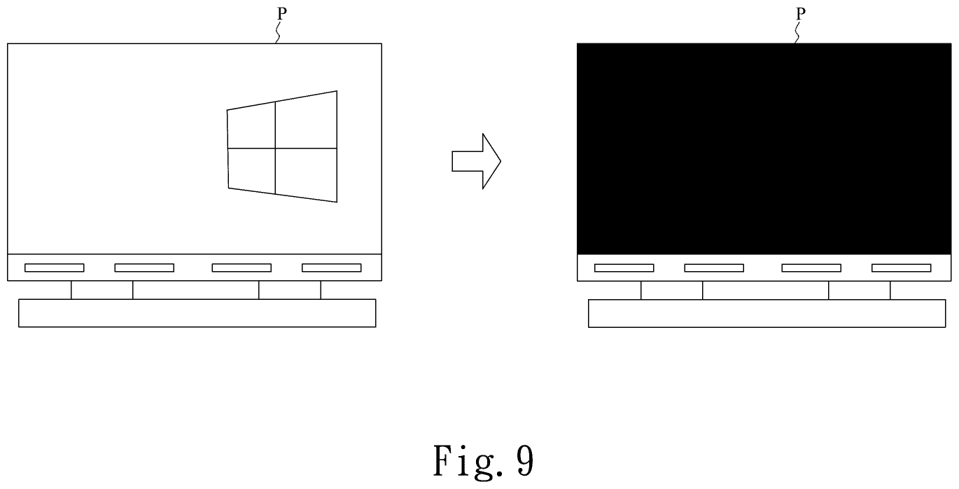

FIG. 9 is a diagram schematically illustrating the screen presentation of a display panel corresponding to FIG. 7. Referring to FIG. 7 and FIG. 9, the left display panel P shows a window in time periods T1 and T2 and the right display panel P shows a black picture in time period T2′. Accordingly, the control method can repeatedly show a black picture to avoid afterimage retention and polarization phenomena when noise interference is detected for a long time.

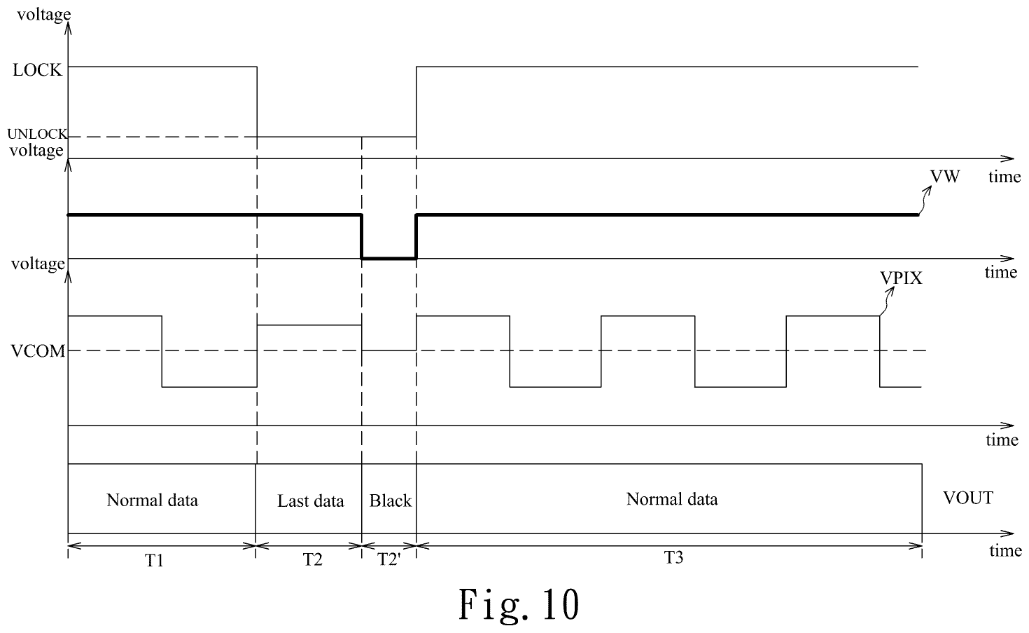

FIG. 10 is a diagram schematically illustrating the status of driving voltage and the waveforms of a synchronization signal, an asynchronization signal, a wake signal, a pixel voltage, and a common voltage according to further embodiment of the invention. Referring to FIG. 1, FIG. 2, and FIG. 10, time periods T1, T2, T2′, and T3 sequentially occurs. In time period T1, the display driver 11 sets the synchronization signal LOCK being a high-level voltage and transmits the synchronization signal LOCK to the timing controller 10. Simultaneously, the wake signal VW is a high-level voltage and the driving voltage VOUT comes from normal data. In time period T2, the display driver 11 sets the asynchronization signal UNLOCK being a low-level voltage. In time period T2, the timing controller 10 determines that the time duration of the asynchronization signal UNLOCK is less than the given time duration, such that the display driver 11 performs a noise interference mode and the wake signal VW is still a high-level voltage. In the noise interference mode, the display driver 11 may keep the last driving voltage VOUT in time period T2. In time period T2′ and after the noise interference mode, the timing controller 10 determines that the time duration of the asynchronization signal UNLOCK is greater than or equal to the given time duration, such that the display driver 11 performs a crash reset mode and the wake signal VW has a negative pulse. In the crash reset mode, the display driver 11 may adjust the last diving voltage VOUT to be equal to the common voltage VCOM applied to the common electrode of the pixel liquid-crystal capacitor CPIX until the time duration of the asynchronization signal UNLOCK ends. In time period T3, the display driver 11 sets the synchronization signal LOCK being a high-level voltage and transmits the synchronization signal LOCK to the timing controller 10. Simultaneously, the wake signal VW is still a high-level voltage and the display driver 11 receives input data D from the timing controller 10 to generate new driving voltage VOUT that comes from normal data.

In some embodiments of the invention, the display controller 113 receives the negative pulse of the wake signal VW to control the amplifying circuit 111 and the output switching circuit 112, thereby adjusting the last diving voltage VOUT to be equal to the common voltage VCOM applied to the common electrode of the pixel liquid-crystal capacitor CPIX until the time duration of the asynchronization signal UNLOCK ends.

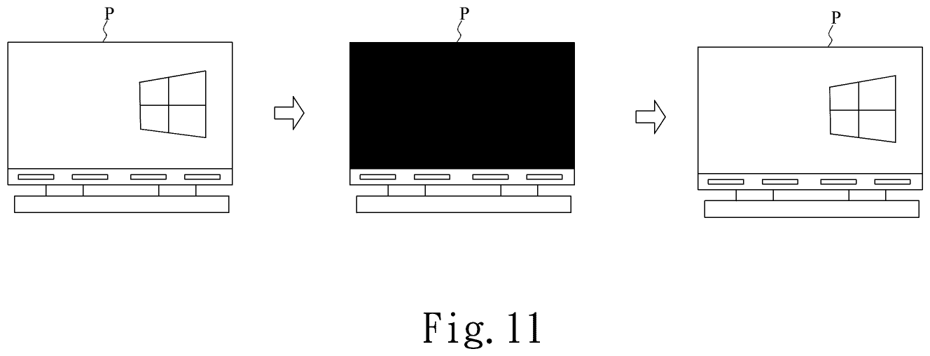

FIG. 11 is a diagram schematically illustrating the screen presentation of a display panel corresponding to FIG. 10. Referring to FIG. 10 and FIG. 11, the left display panel P shows a window in time periods T1 and T2, the middle display panel P shows a black picture in time period T2′, and the right display panel P shows a window in time period T3. Accordingly, the control method avoid afterimage retention and polarization phenomena after noise interference is detected for a long time.

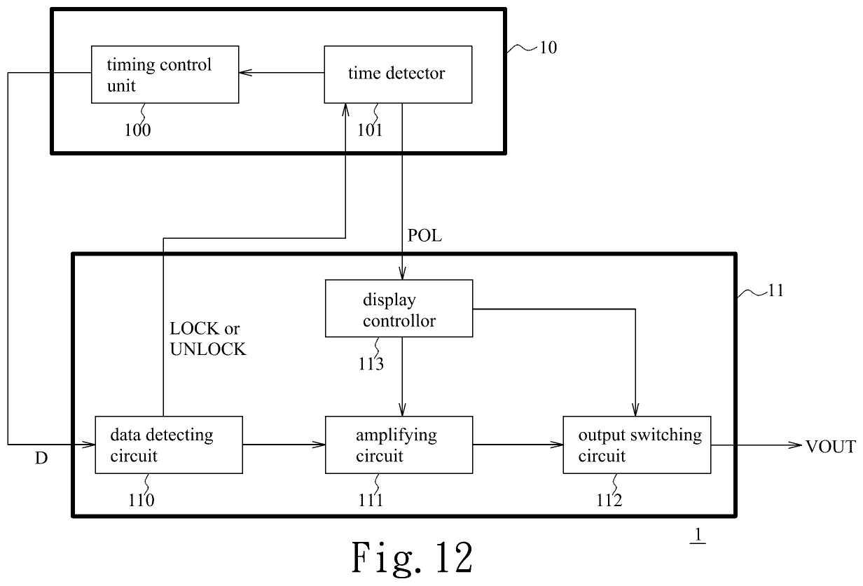

FIG. 12 is a diagram schematically illustrating a display control circuit according to a third embodiment of the invention. Referring to FIG. 12 and FIG. 1, the third embodiment of the display control circuit will be introduced as follows. The third embodiment of FIG. 12 is different from the first embodiment of FIG. 1 in that the third embodiment of FIG. 12 uses a polarity signal POL to replace the wake signal VW in the first embodiment of FIG. 1. The other features of FIG. 12 have been described previously so they will not be reiterated.

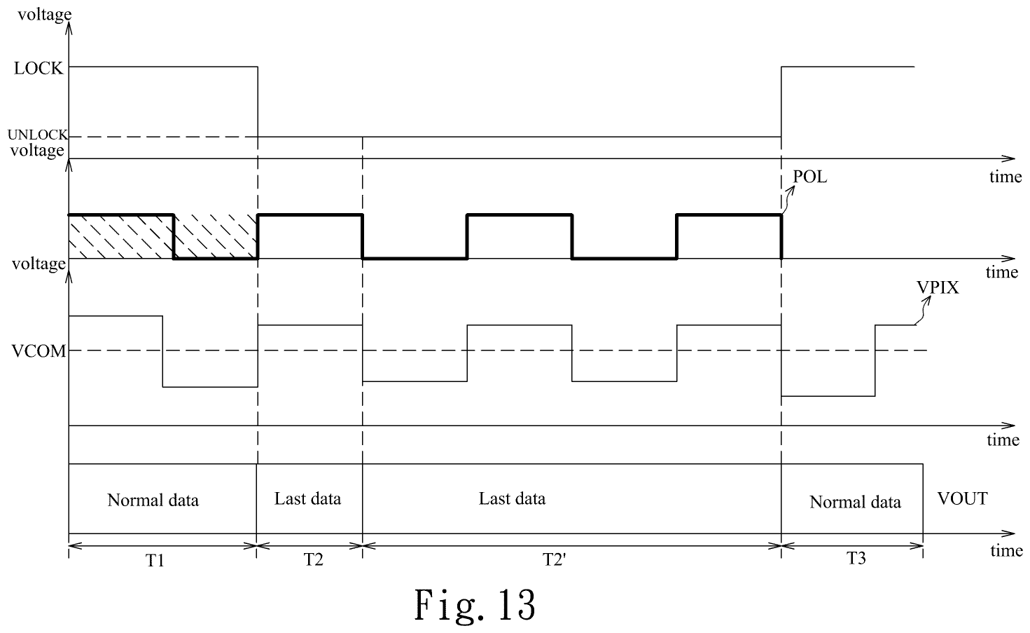

FIG. 13 is a diagram schematically illustrating the status of driving voltage and the waveforms of a synchronization signal, an asynchronization signal, a polarity signal, a pixel voltage, and a common voltage according to an embodiment of the invention. Referring to FIG. 12, FIG. 2, and FIG. 13, time periods T1, T2, T2′, and T3 sequentially occurs. In time period T1, the display driver 11 sets the synchronization signal LOCK being a high-level voltage and transmits the synchronization signal LOCK to the timing controller 10. Simultaneously, the polarity signal POL may be, but not limited to, an alternating-current (AC) square signal and the last driving voltage VOUT comes from normal data. In time period T2, the display driver 11 sets the asynchronization signal UNLOCK being a low-level voltage. In time period T2, the timing controller 10 determines that the time duration of the asynchronization signal UNLOCK is less than the given time duration, such that the display driver 11 performs a noise interference mode and the polarity signal POL may be still the AC normal square signal. In the noise interference mode, the display driver 11 may keep the last driving voltage VOUT in time period T2. In time period T2′ and after the noise interference mode, the timing controller 10 determines that the time duration of the asynchronization signal UNLOCK is greater than or equal to the given time duration, such that the display driver 11 performs a crash reset mode and the polarity signal POL is an AC control square signal. In the crash reset mode, the display driver 11 may repeatedly change the polarity of the last driving voltage VOUT prior to occurrence of the asynchronization signal UNLOCK until the time duration of the asynchronization signal UNLOCK ends. When the polarity of the driving voltage VOUT is changed, the polarity of the pixel voltage VPIX is changed. Thus, the average value of the pixel voltages VPIX is almost zero to avoid polarization phenomena in time period T2′. In time period T3, the display driver 11 sets the synchronization signal LOCK being a high-level voltage and transmits the synchronization signal LOCK to the timing controller 10. Simultaneously, the polarity signal POL is still the AC normal square signal and the display driver 11 receives input data D from the timing controller 10 to generate new driving voltage VOUT that comes from normal data.

In some embodiments of the invention, the display controller 113 receives the polarity signal POL being the AC control square signal to control the amplifying circuit 111 and the output switching circuit 112, thereby repeatedly changing the polarity of the last driving voltage VOUT until the time duration of the asynchronization signal UNLOCK ends.

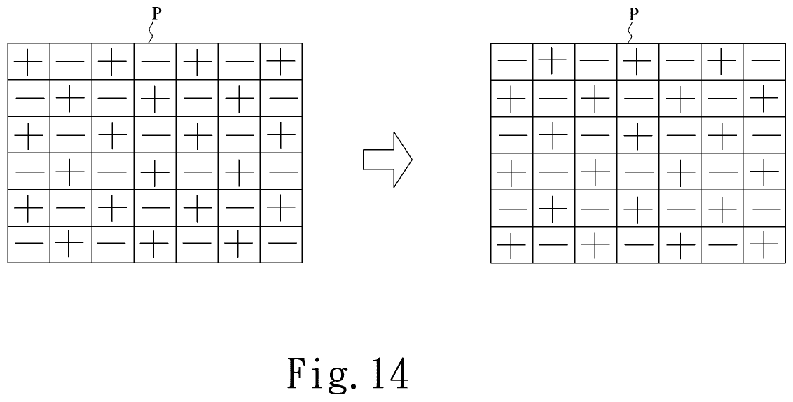

FIG. 14 is a diagram schematically illustrating the pixels of a display panel for performing dot inversion according to an embodiment of the invention. Referring to FIG. 14, the display panel P has 42 pixels each having a positive polarity or a negative polarity. The display panel P can perform row inversion, column inversion, frame inversion, or dot inversion, but the invention is not limited thereto. For example, when the display panel P performs dot inversion to display at least one image frame, the positive polarity of the pixel is changed to the negative polarity in next frame, and the negative polarity of the pixel is changed to the positive polarity in next frame. The time duration for displaying one image frame is equal to the time duration for sequentially enabling all scan lines of the display panel P.

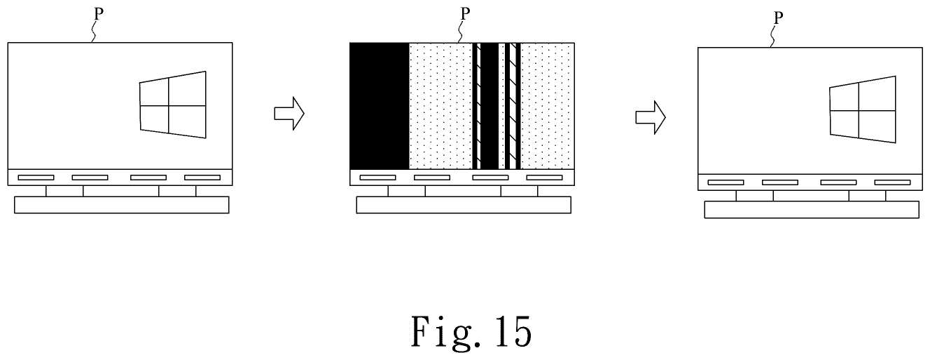

FIG. 15 is a diagram schematically illustrating the screen presentation of a display panel corresponding to FIG. 13. Referring to FIG. 13 and FIG. 15, the left display panel P shows a window in time periods T1 and T2, the middle display panel P shows a polarity-changed picture in time period T2′, and the right display panel P shows a window in time period T3. Accordingly, the control method avoid afterimage retention and polarization phenomena after noise interference is detected for a long time.

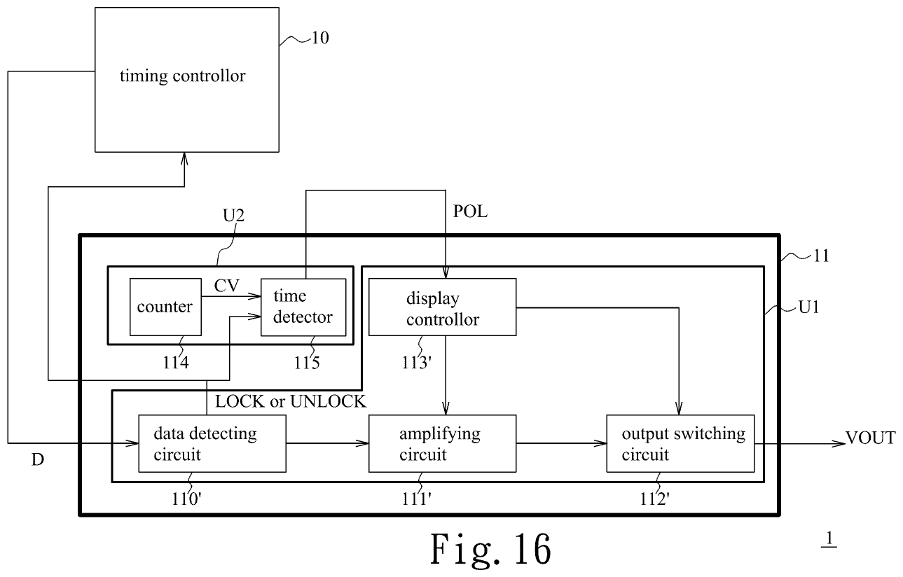

FIG. 16 is a diagram schematically illustrating a display control circuit according to a fourth embodiment of the invention. Referring to FIG. 16 and FIG. 6, the fourth embodiment of the display control circuit will be introduced as follows. The fourth embodiment of FIG. 16 is different from the second embodiment of FIG. 6 in that the fourth embodiment of FIG. 16 uses a polarity signal POL to replace the wake signal VW in the second embodiment of FIG. 6. The other features of FIG. 16 have been described previously so they will not be reiterated.

Referring to FIG. 13, FIG. 2, and FIG. 16, time periods T1, T2, T2′, and T3 sequentially occurs. In time period T1, the display driver 11 sets the synchronization signal LOCK being a high-level voltage and transmits the synchronization signal LOCK to the timing controller 10. Simultaneously, the polarity signal POL may be, but not limited to, an alternating-current (AC) square signal and the driving voltage VOUT comes from normal data. In time period T2, the display driver 11 sets the asynchronization signal UNLOCK being a low-level voltage. In time period T2, the display driver 11 determines that the time duration of the asynchronization signal UNLOCK is less than the given time duration, such that the display driver 11 performs a noise interference mode and the polarity signal POL may be still the AC normal square signal. In the noise interference mode, the display driver 11 may keep the last driving voltage VOUT in time period T2. In time period T2′ and after the noise interference mode, the display driver 11 determines that the time duration of the asynchronization signal UNLOCK is greater than or equal to the given time duration, such that the display driver 11 performs a crash reset mode and the polarity signal POL is an AC control square signal. In the crash reset mode, the display driver 11 may repeatedly change the polarity of the last driving voltage VOUT until the time duration of the asynchronization signal UNLOCK ends. Thus, the average value of the pixel voltages VPIX is almost zero to avoid polarization phenomena in time period T2′. In time period T3, the display driver 11 sets the synchronization signal LOCK being a high-level voltage and transmits the synchronization signal LOCK to the timing controller 10. Simultaneously, the polarity signal POL is still the AC normal square signal and the display driver 11 receives input data D from the timing controller 10 to generate new driving voltage VOUT that comes from normal data.

In some embodiments of the invention, the display controller 113′ receives the polarity signal POL being the AC control square signal to control the amplifying circuit 111′ and the output switching circuit 112′, thereby repeatedly changing the polarity of the last driving voltage VOUT until the time duration of the asynchronization signal UNLOCK ends.

According to the embodiments provided above, the display control circuit for detecting noise interference and the control method thereof perform a noise interference mode or a crash reset mode based on the given time duration and the time duration of an asynchronization signal which indicates that the timing controller is desynchronized from the display driver, thereby avoiding screen abnormalities and afterimage retention.

The embodiments described above are only to exemplify the invention but not to limit the scope of the invention. Therefore, any equivalent modification or variation according to the shapes, structures, features, or spirit disclosed by the invention is to be also included within the scope of the invention.

What is claimed is:

1. A control method of a display control circuit that comprises a timing controller and a display driver, comprising:
setting an asynchronization signal which indicates that the timing controller is desynchronized from the display driver;
when determining that a time duration of the asynchronization signal is less than a given time duration, performing a noise interference mode; and
after performing the noise interference mode and when determining that the time duration of the asynchronization signal is equal to or greater than the given time duration, performing a crash reset mode.

2. The control method according to claim 1, wherein in the noise interference mode, a last driving voltage prior to occurrence of the asynchronization signal is kept for the time duration of the asynchronization signal.

3. The control method according to claim 1, wherein in the crash reset mode, a last driving voltage prior to occurrence of the asynchronization signal is adjusted to be equal to a common voltage applied to a common electrode until the time duration of the asynchronization signal ends.

4. The control method according to claim 1, wherein in the crash reset mode, a polarity of a last driving voltage prior to occurrence of the asynchronization signal is repeatedly changed until the time duration of the asynchronization signal ends.

5. The control method according to claim 1, wherein the given time duration is a time duration for enabling at least one scan line or displaying at least one image frame.

6. A display control circuit comprising:
a timing controller; and
a display driver coupled to the timing controller and configured to set an asynchronization signal which indicates that the timing controller is desynchronized from the display driver;
wherein when the timing controller determines that a time duration of the asynchronization signal is less than a given time duration, the display driver performs a noise interference mode;
wherein after the noise interference mode is performed and when the timing controller determines that the time duration of the asynchronization signal is equal to or greater than the given time duration, the display driver performs a crash reset mode.

7. The display control circuit according to claim 6, wherein in the noise interference mode, the display driver keeps a last driving voltage prior to occurrence of the asynchronization signal for the time duration of the asynchronization signal.

8. The display control circuit according to claim 6, wherein in the crash reset mode, the display driver adjusts a last driving voltage prior to occurrence of the asynchronization signal to be equal to a common voltage applied to a common electrode until the time duration of the asynchronization signal ends.

9. The display control circuit according to claim 6, wherein in the crash reset mode, the display driver repeatedly changes a polarity of a last driving voltage prior to occurrence of the asynchronization signal until the time duration of the asynchronization signal ends.

10. The display control circuit according to claim 6, wherein the given time duration is a time duration for enabling at least one scan line or displaying at least one image frame.

11. The display control circuit according to claim 6, wherein the timing controller includes:
a timing control unit coupled to the display driver; and
a time detector coupled to the timing control unit and the display driver and configured to determine the time duration of the asynchronization signal.

12. A display control circuit comprising:
a timing controller; and
a display driver coupled to the timing controller and configured to set an asynchronization signal which indicates that the timing controller is desynchronized from the display driver;
wherein when the display driver determines that a time duration of the asynchronization signal is less than a given time duration, the display driver performs a noise interference mode;
wherein after the noise interference mode is performed and when the display driver determines that the time duration of the asynchronization signal is equal to or greater than the given time duration, the display driver performs a crash reset mode.

13. The display control circuit according to claim 12, wherein in the noise interference mode, the display driver keeps a last driving voltage prior to occurrence of the asynchronization signal for the time duration of the asynchronization signal.

14. The display control circuit according to claim 12, wherein in the crash reset mode, the display driver adjusts a last driving voltage prior to occurrence of the asynchronization signal to be equal to a common voltage applied to a common electrode until the time duration of the asynchronization signal ends.

15. The display control circuit according to claim 12, wherein in the crash reset mode, the display driver repeatedly changes a polarity of a last driving voltage prior to occurrence of the asynchronization signal until the time duration of the asynchronization signal ends.

16. The display control circuit according to claim 12, wherein the given time duration is a time duration for enabling at least one scan line or displaying at least one image frame.

17. The display control circuit according to claim 12, wherein the display driver includes:
a display driving unit coupled to the timing controller and configured to set the asynchronization signal; and
a time detecting unit coupled to the display driving unit and configured to determine the time duration of the asynchronization signal.

18. The display control circuit according to claim 17, wherein the time detecting unit includes:
a counter configured to providing a count value; and
a time detector coupled to the counter and the display driving unit and configured to determine the time duration of the asynchronization signal based on the count value.
